(19) United States
(12) Patent Application Publication
(10) Pub. No.: US 2007/0033298 A1
(43) Pub. Date: Feb. 8, 2007

(54) Command controller

(76) Inventor: John Bantner, Jacksonville, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/501,367

(22) Filed: Aug. 8, 2006

Related U.S. Application Data
(60) Provisional application No. 60/706,383, filed on Aug. 8, 2005.

(51) Int. Cl. G06F 3/00

(52) U.S. Cl. 710/5

(57) ABSTRACT

A command controller and method for exchanging commands between devices in a multi-device system are disclosed. In some embodiments a command controller provides programmable daisy-chaining of commands between devices depending on the status of at least one of the devices. In some embodiments a command sent to cause an action in a specific device can also be transformed into a different command destined for another device. Some embodiments may provide command memory mapping to allow any input command to a device to perform any specified action in the device and also check a status bit in the device for determining if an output command is to be generated. Generally, a command controller may provide a command interpreter that allows more control to be distributed throughout connected but otherwise incompatible devices instead of having all of the control functions reside in control points within a network of devices.

### CROSS-REFERENCE TO RELATED APPLICATION

This application claims the benefit of U.S. Provisional Application No. 60/706,383, filed Aug. 8, 2005, which is incorporated herein by reference.

### BACKGROUND

Industrial manufacturing requires coordination of multiple devices to achieve certain tasks. A conventional industrial manufacturing system may include multiple devices such as an oscilloscope, stamping machines, injection molding machines, and other similar devices used in manufacturing. These multiple devices are generally made by different manufacturers and are typically either coordinated with considerable human involvement or by limited control points such as programmable logic controllers.

A programmable logic controller (PLC) is a small and often robust computer used in industrial manufacturing systems and assembly lines. The PLC typically includes a programmable read only memory, a microprocessor, and inputs and outputs connecting the PLC to sensors, actuators, limit switches, temperature indicators, complex positioning systems, etc.

PLCs may be reconfigured in software as opposed to re-wiring hard-wired control panels. PLCs provide generic solutions that work in less complicated industrial manufacturing and typically are programmed with ladder logic. Ladder logic provides limited functionality and is often not compatible between different PLCs.

Another user configurable controller is a field programmable gate array (FPGA). An FPGA is a semiconductor device with programmable logic components (logic blocks) and with programmable interconnects. The programmable logic components can be programmed to duplicate the functionality of basic logic gates or can even be programmed with more complex combinational functions such as decoders, multipliers, etc. In most FPGAs, these logic blocks may also include memory elements, ranging from simple flip-flops to entire blocks of random access memory (RAM). FPGAs typically have programmable interconnects between the logic blocks.

Conventionally, both PLCs and FPGAs operate as a centralized controller in industrial manufacturing systems wherein the central control can actually be a barrier to inter device communications. Ultimately, this can impact the utility of industrial systems.

### SUMMARY

Some embodiments may provide a command controller including a plurality of inputs and outputs to send and receive signals from devices, a plurality of memory blocks comprising commands for the devices wherein the memory blocks are connected with the plurality of inputs and outputs, a pass through logic coupled with some of the plurality of inputs and outputs, the pass through logic to enable a selected device to conditionally generate an output command from an input command based on the status of the selected device and a command execution logic coupled with some of the plurality of inputs and outputs, the command execution logic to translate a general purpose command received on an input into a specific executable command for the selected device.

Another embodiment may provide a method comprising receiving a command from a device, conditionally generating output commands based on the status of the device, then translating a general purpose command into a specific executable command for the device and sending the specific executable command to the device.

Another embodiment may be a command controller system comprising a plurality of devices to send and receive commands and a command controller coupled with the devices, the command controller comprising a plurality of inputs and outputs to send and receive signals from devices, a plurality of memory blocks comprising commands for the devices, the memory blocks connected with the plurality of inputs and outputs, a pass through logic coupled with some of the plurality of inputs and outputs, the pass through logic to enable a selected device to conditionally generate an output command from an input command based on the status of the selected device, and a command execution logic coupled with some of the plurality of inputs and outputs, the command execution logic to translate a general purpose command received on an input into a specific executable command for the selected device.

### BRIEF DESCRIPTION OF DRAWINGS

The present disclosure will be described by way of exemplary embodiments, but not limitations, illustrated in the accompanying drawings in which like references denote similar elements, and in which:

FIG. 1 illustrates an embodiment command controller.

FIG. 2 is a flow diagram illustrating an embodiment method for a command controller.

### DETAILED DESCRIPTION

In the following description, various aspects of a command controller will be described. Specific details will be set forth in order to provide a thorough understanding of the present disclosure. However, it will be apparent to those skilled in the art that the present invention may be practiced with only some or all of the described aspects of the present disclosure, and with or without some or all of the specific details. In some instances, well-known features may be omitted or simplified in order not to obscure the present invention. Repeated usage of the phrase “in one embodiment” does not necessarily refer to the same embodiment, although it may.

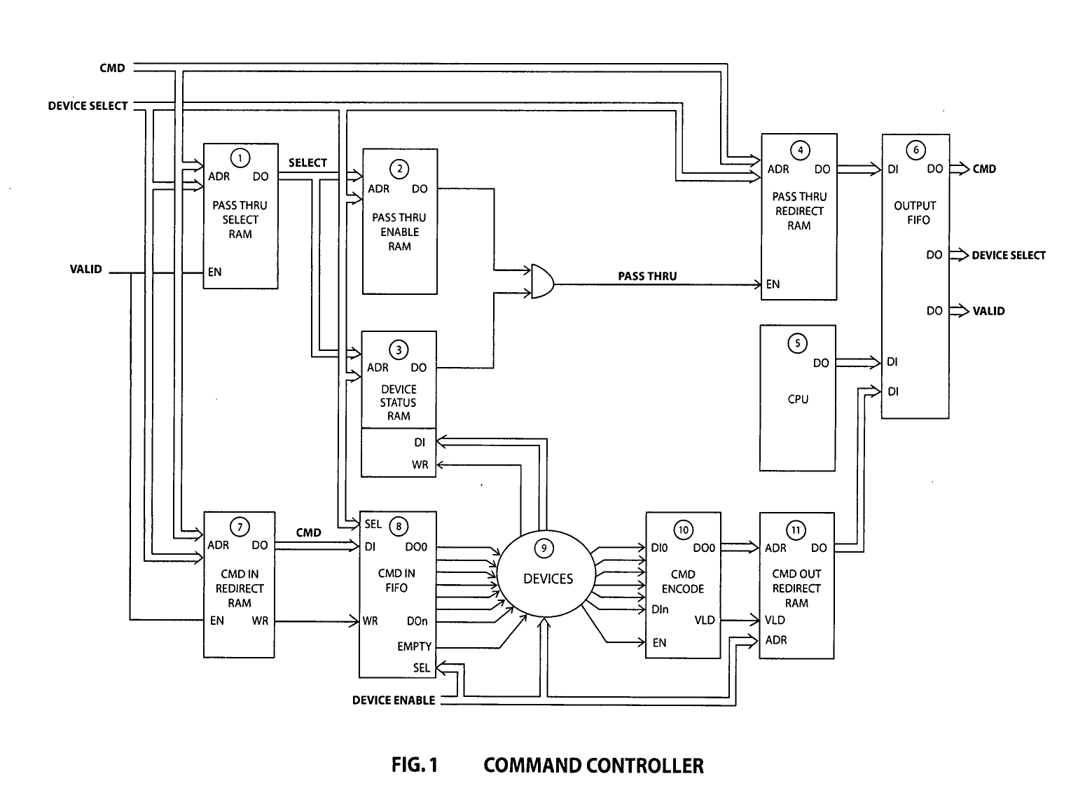

FIG. 1 illustrates an embodiment command controller configured in a FPGA with logic blocks including memory blocks, a pass through logic, a command execution logic, and a central processing unit (CPU) 5, as well as an example connected device 9, and various command and select buses to coordinate the logic blocks as described herein, but other embodiments need not be so limited.

The command controller in FIG. 1 comprises a plurality of inputs and outputs to send and receive signals from devices such as example device 9. The command controller may further include a plurality of memory blocks such as pass through select memory 1, pass through enable memory 2, device status memory 3, command in redirect memory 7, command in first in first out (FIFO) buffer 8, pass through redirect memory 4, command out redirect memory 11, and output FIFO 6, as illustrated. Other embodiments may differ in arrangement or inclusion of these logic blocks but still be within the scope of this disclosure.

According to the embodiment in FIG. 1, a pass through logic may be created that includes pass through select memory 1, pass through enable memory 2, device status memory 3, and pass through redirect memory 4. The pass through logic enables a selected device to conditionally generate an output command from an input command based on the status of the selected device, as described below. Additionally, the embodiment in FIG. 1 includes a command execution logic that includes command in redirect memory 7, command in FIFO buffer 8, example device 9, a command encoder 10, and a command out redirect memory 11. According to one embodiment, the command execution logic can translate a general purpose command received on an input into a specific executable command for a selected device. FIG. 1 illustrates many of the memory blocks as random access memory (RAM) blocks, but embodiments need not be so limited.

Embodiments of the present disclosure may relate broadly to interactive devices used in electronic systems. Specifically, a command controller allows a first device to control a second device, and at a later time the second device to control the first device. Therefore, multiple devices that otherwise do not have compatible commands may be capable of controlling each other and/or being controlled by each other.

Some embodiments may use RAM to remap both the input commands to a command controller and the commands output from the command controller while monitoring the status of multiple devices.

Referring back to the embodiment in FIG. 1, an example command flow for device 9 will now be described. Most embodiments will have multiple devices and can arbitrate between them based on a device select value and a device select bus, although this is not required in all embodiments. In the present embodiment, the device select bus may be 64 channels wide, thus allowing 64 devices to be controlled by the command controller, but embodiments need not be so limited.

As illustrated in FIG. 1, commands enter the command controller on the left and exit the command controller on the right. As discussed above, the bottom portion of FIG. 1 provides command execution for the device, while the top portion of FIG. 1 provides a pass through to allow daisy-chaining of commands between different devices.

If device 9 executes an input command, that input command may cause the device to generate an output command. In some embodiments, to prevent output commands from interfering with each other, only a single device may be allowed to execute input commands at any one time. For example, an embodiment may be synchronous with a master timer providing each device in the system a unique time slot, during which the device is allowed to execute input commands and/or generate output commands.

An enabled device 9 can generate a single output command that could be daisy-chained to multiple devices in the system and cause command executions in all of those devices. According to one embodiment, if a device 9 is not enabled, it may receive input commands but not be allowed to execute input commands or to generate output commands. In some embodiments, pass through commands are always executed regardless of the device's enabled state.

In the embodiment illustrated in FIG. 1, the contents of all memory lookup and redirect tables in the command controller are readable and writeable by the CPU 5 except the device status memory 3 whose contents are determined only by the selected device, but other embodiments need not be so limited.

Command Execution

According to the present embodiment, command in redirect memory 7 can translate any general purpose command generated by the command controller into a specific executable command for the selected device 9 under the control of the CPU 5. An input command and a device select value are applied to a command in redirect memory 7, where the input command is redirected into an executable command specific to the selected device 9. Since the input command is remapped at memory 7, different input commands may generate the same executable output command. In some embodiments different input commands may also generate no executable command.

According to the present embodiment, the command in redirect memory 7 is programmable so that the CPU 5 can control the command execution of selected device 9. The translated commands from the command in memory 7 may then be passed to command in FIFO 8 prior to execution by the selected device 9. The command FIFO 8 allows the system to synchronize by allowing only one enabled device 9 to execute commands at any one time. Input commands may arrive at the selected device 9 at any time, so they can be stored in the command FIFO until the selected device is enabled for command execution. The output of the command in FIFO 8 may then be decoded by the selected device 9 and may perform the same specific action within that device.

When the device 9 is enabled, specific actions within the device can cause output commands to be encoded in command encoder 10 and sent to the command out redirect memory 11, which can translate any specific command generated by the enabled device 9 into a general purpose command used by the command controller. Additionally, the command out redirect memory 11 can specify the selected device 9 that is the destination of the translated command.

In some embodiments, the contents of the command out redirect memory 11 are under control of the CPU 5. The command from the command output redirect memory 11 is sent to the output FIFO 6 prior to being executed, as the system may be busy executing a previous device command, or CPU 5 may be busy executing a command. In either case, the output FIFO 6 may check if a previous command has finished before it allows the execution of the next command.

Command Daisy-Chaining

According to the present embodiment, input pass through select memory 1 can translate general purpose input commands into a pass through command qualifier by selecting both a specific device status bit stored in device status memory 3 and its accompanying pass through enable bit stored in pass through enable memory 2 for a selected device 9 specified by a device select signal.

In the present embodiment, if the status bit agrees with the pass through enable bit, then the command controller can generate an output command. This structure can be used to enable a selected device to conditionally generate output commands from an input command using the status of the selected device while at the same time possibly using the same input command as a command to the device. If the device status bit stored in device status memory 3 and pass through enable bit stored in pass through enable memory 2 do not agree, then no new output command is generated, and the command daisy-string is terminated. Other embodiments may use disagreement between the device status bit and the pass through enable bit to conditionally generate an output command.

In some embodiments, the device status memory 3 is a dual port memory where each device 9 updates the device status memory 3 when any change in its status occurs. The other port of device status memory 3 can then be used to report the device status currently selected by the device select signal and the pass through select memory 1 to determine whether an output command should be generated.

Referring back to the embodiment in FIG. 1, the pass through enable memory 2 can be the qualifier for the device status memory 3, which can also be selected by the device select signal and the pass through select memory 1. The CPU 5 can set a bit in the pass through enable memory 2 that, when compared with its corresponding bit in the device status memory 3, either allows an output command to be generated or the command daisy-string to be terminated.

In the present embodiment, the pass through redirect memory 4 can both translate an input command into an output command and specify the device to which the translated command is sent. In some embodiments, the pass through redirect memory 4 can be limited to enabling only if the pass through enable and the device status conditions are met. The pass through redirect memory 4 is programmable so that the CPU 5 can control the daisy-chain command generation of the selected device 9 and specify the destination of that command.

Hierarchy

According to an embodiment, multiple devices, such as device 9, can share the same command and device select structure. A device 9 may be a member of multiple command controllers and may even serve as the master timer for any command controller. If a device is a member of multiple command controllers, then it may be separately enabled by each of those command controllers and may generate command outputs only to the command controller that is enabling it.

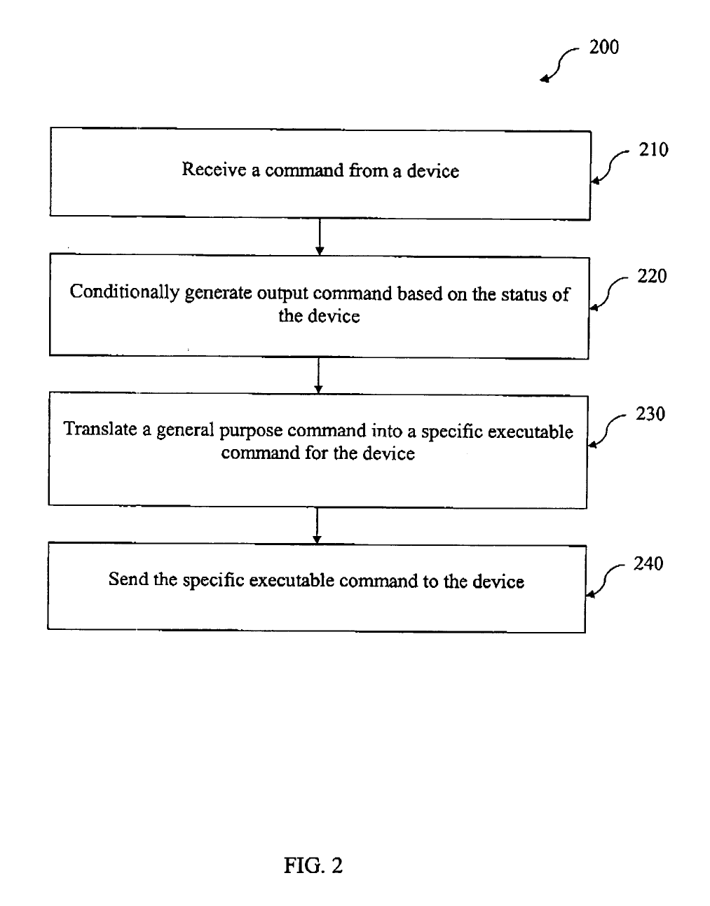

FIG. 2 is a flow diagram illustrating a method 200 for a command controller. Other embodiments may use various methods to implement the command controller in this detailed description and its equivalents.

Referring to FIG. 2, method 200 receives a command from a device in block 210. In some embodiments, multiple commands can be received from multiple devices. After a command is received, block 220 shows conditional generation of an output command based on the status of the device. Then method 200 can translate a general purpose command into a specific executable command for the device as illustrated in block 230. Method 200 then can send the specific executable command to the device as illustrated in block 240.

It should be noted that block 220 and block 230 may be switched conditionally, that is, method 200 may default to translating a general purpose command into a specific executable command for the device and then conditionally generate output commands based on the status of the device.

Some embodiments can provide a method for any device in the system to send commands to any other device in the system of devices that otherwise do not support each other's device commands. Some embodiments have a command structure allowing a method to have the same command sent to similar devices to perform different functions in those devices.

Additionally, embodiment methods can provide for the daisy-chaining of commands whereby an input command to a device can be transformed into an output command that may be different from the input command and may be sent back to the current device or sent to another device. In the present embodiment, commands may be daisy-chained based on the current status of the receiving device.

Some embodiments may comprise a machine-readable medium containing instructions that, when executed by a processor, cause a machine to perform method 200. Additionally or alternatively, the machine-readable medium may also include instructions that can cause a machine to perform other aspects of this disclosure, as described herein, and their equivalents.

From the foregoing description, those skilled in the art will recognize that many other variations of the present disclosure are possible. Thus, the present invention is not limited by the details described. Instead, the present invention can be practiced with modifications and alterations within the spirit and scope of the appended claims.

What is claimed is:

1. A command controller comprising:
a plurality of inputs and outputs to send and receive signals to and from devices;
a plurality of memory blocks comprising commands for the devices, the memory blocks connected with the plurality of inputs and outputs;
a pass through logic coupled with some of the plurality of inputs and outputs, the pass through logic to enable a selected device to conditionally generate an output command from an input command based on a status of the selected device; and
a command execution logic coupled with some of the plurality of inputs and outputs, the command execution logic to translate a general purpose command received at an input into a specific executable command for the selected device.

2. The command controller of claim 1, wherein the pass through logic includes a pass through select memory, a pass through enable memory and a device status memory, wherein the pass through logic can generate an output command when a device status bit in the pass through enable memory is in agreement with a pass through enable bit in the device status memory.

3. The command controller of claim 2, wherein the pass through logic further includes a pass through redirect memory to translate an input command into an output command and specify a device to send the output command.

4. The command controller of claim 1, wherein the command execution logic includes a command buffer to store specific executable commands for multiple devices.

5. The command controller of claim 1, further comprising a synchronization subsystem to synchronize signals from multiple devices.

6. A method comprising:
receiving a command from a device;
conditionally generating output commands based on the status of the device;
translating a general purpose command into a specific executable command for the device; and
sending the specific executable command to the device.

7. The method of claim 6 further comprising programmably daisy-chaining commands between devices.

8. The method of claim 6 further comprising memory mapping the command received from the device so the device can perform any action to which the command is memory mapped.

9. The method of claim 8, wherein memory mapping the command allows a received command to test the device status bit of a device to determine if an output command is to be generated.

10. A command controller system comprising:
a plurality of devices to send and receive commands;
a command controller coupled with the devices, the command controller comprising:
a plurality of inputs and outputs to send and receive signals to and from devices;
a plurality of memory blocks comprising commands for the devices, the memory blocks connected with the plurality of inputs and outputs;
a pass through logic coupled with some of the plurality of inputs and outputs, the pass through logic to enable a selected device to conditionally generate an output command from an input command based on a status of the selected device; and
a command execution logic coupled with some of the plurality of inputs and outputs, the command execution logic to translate a general purpose command received at an input into a specific executable command for the selected device.

11. The command controller system of claim 10, wherein the pass through logic includes a pass through select memory, a pass through enable memory and a device status memory, wherein the pass through logic can generate an output command when a device status bit in the pass through enable memory is in agreement with a pass through enable bit in the device status memory.

12. The command controller of claim 11, wherein the pass through logic further includes a pass through redirect memory to translate an input command into an output command and specify a device to send the output command.

13. The command controller system of claim 10, wherein the command execution logic includes a command buffer to store specific executable commands for multiple devices.

14. The command controller system of claim 10, further comprising a synchronization subsystem to synchronize signals from multiple devices.

15. A machine-readable medium having stored thereon a set of instructions that, if executed by a machine, cause the machine to:
receive a command from a device;
conditionally generate output commands based on the status of the device;
translate a general purpose command into a specific executable command for the device; and
send the specific executable command to the device.

16. The machine-readable medium of claim 15, wherein the instructions further cause the machine to programmably daisy-chain commands between devices.

17. The machine-readable medium of claim 15, wherein the instructions further cause the machine to memory map the command received from the device so the device can perform any action to which the command is memory mapped.

18. The machine-readable medium of claim 17, wherein the instructions that cause the machine to memory map the command further allows a received command to test the device status bit of a device to determine if an output command is to be generated.
